(19) United States
(12) Patent Application Publication
(10) Pub. No.: US 2012/0142512 A1
(43) Pub. Date: Jun. 7, 2012

(54) Machine For The Manufacture Of Paper Cushions

(75) Inventor: Reinhard Keller, Bottighofen (CH)

(73) Assignee: Pack-Tiger GmbH, Daettlikon (CH)

(21) Appl. No.: 12/513,656

(22) PCT Filed: Sep. 27, 2007
(86) PCT No.: PCT/EP07/08427

§ 371 Date: Jan. 28, 2010

(30) Foreign Application Priority Data
Nov. 20, 2006 (DE) 10 2006 054 593.1

(51) Int. Cl. B31F 1/00

(52) U.S. Cl. 493/461

(57) ABSTRACT

The present invention relates to a machine for producing paper dunnage, which machine comprises a forming device (22, 22′, 22″) and a housing (2) which is penetrated by a guide channel (62). A drive (3, 54, 58) is provided in the housing, in order to convey a paper web (8) along a main transport direction through the forming device and the guide channel. The arrangement and/or the design of the guide channel after the paper web emerges from the forming device brings about a deflection in the main transport direction from a first direction (A) into a second direction (B).

The present invention relates to a machine for the manufacture of paper cushions in accordance with the preamble of claim 1.

A machine of this type is known, for example, from WO 00/07808 as well as from EP 1 645 406 A1.

In particular with the machine described in EP 1 645 406 A1, the final production step in the manufacture of the paper cushions takes place in the housing above the shaping device so that the manufacture of the paper cushions takes place in a straight production line which extends from the bottom to the top and takes up a comparatively large space. In addition, with the known machine for the manufacture of paper cushions, it may be necessary to provide a conveying apparatus to be able to supply the individual paper cushions directly to a storage container after their manufacture, which is due to the fact that the paper cushions manufactured do not leave the housing of the paper machine directly in a defined direction.

It is therefore an object of the present invention to improve a machine of the initially named kind at least such that the machine takes up less space.

This object is satisfied by a machine which has the features of claim 1. The object is in particular satisfied in that the guide passage is arranged or configured such that a deflection takes place in the main direction of transport from a first direction to a second direction after the paper web exits the shaping device. The first direction can, for example, be the output direction of the paper web from the deflection device and the second direction can be the input direction of the paper web into the guide passage.

To the extent that a main transport direction of the paper web is spoken of here, this is to be understood as the global course of the paper web through the shaping device and through the guide passage, with a potential plurality of smaller deflections within the shaping device and the guide passage remaining out of consideration.

The guide passage can be inclined or angled with respect to the shaping device due to the special arrangement and/or formation of the guide passage in accordance with the invention, whereby the machine takes up less space in the conveying direction through the shaping device so that the machine can also be used in tight space conditions.

Furthermore, the paper web still present as endless material is subjected to an additional shaping due to the special arrangement and/or design of the guide passage after it has already been preshaped by the shaping device. Since the paper cushions to be manufactured are, however, too short to be subjected to such a shaping, this additional shaping should be carried out by curving the paper web already preshaped by the shaping device as long as the paper web is still present as endless material.

Since the final production step in the manufacture of paper cushions takes place in the housing when the known machines are used, said housing usually being located above the shaping device thereof, the manufacture of the paper cushions takes place along a main transport direction extending from the bottom to the top, which normally makes it necessary to convey the individual paper cushions away from the machine with the help of a conveying device at the upper end of the production line. Since the guide passage is arranged and/or designed such that a deflection takes place from a first direction to a second direction in the main transport direction after the paper web exits the shaping device, the paper cushions manufactured in the housing can always be expelled from the housing in the same direction depending on the orientation of the second direction. The paper cushions can thus be collected directly by a storage container to be arranged beneath the exit opening without a conveyer apparatus having to be provided. In accordance with the invention, an additional conveying apparatus can thus be dispensed with due to the special arrangement and/or configuration of the guide passage since the paper cushions manufactured can fall out of the guide passage due to gravity as a result of the special orientation and/or design of the guide passage, provided that the second direction is inclined with respect to the vertical.

Advantageous embodiments of the invention results from the description, from the drawings and from the dependent claims.

The guide passage can thus—at least in the region of the exit opening from the housing, for example—be inclined at an oblique angle with respect to the first direction such that the paper web or the main transport direction thereof undergoes the desired deflection after the shaping device. It can, for example, be sufficient only to angle the guide passage in its end region in order to transport the paper cushions out of the housing in a desired direction. To this extent, it only requires a modification with regard to the guide passage with respect to the known paper cushion machines so that the rest of the machine can remain substantially unchanged. Alternatively to this, however, the total guide passage can also be inclined with respect to the output direction of the paper web from the shaping device. In both cases, the shaping device can maintain its position and alignment in comparison with the already known machines since the desired deflection of the paper web or of the main transport direction can be effected solely by the optionally regional inclination of the guide passage, which can be achieved, for example, by an independent inclination of the housing from the shaping device, with the guide passage extending from said housing.

In accordance with a further embodiment of the invention, the shaping device can have a deflection region in which the paper web or the main transport direction undergoes the desired change in direction. In this connection, the deflection region can be made in one piece with the shaping device so that the deflection device merges continuously into the deflection region. To achieve a change in direction which is as direct as possible, the deflection region can, for example, include an at least partly curved deflection passage which has a design which is curved such that the paper web undergoes the desired change in direction therein. The paper web can be reliably supplied from the shaping device to the guide passage located in the housing by a deflection passage of this type, without undergoing the risk that the paper web is damaged between the shaping device and the housing, which could result in the most unfavorable case in a tear of the paper web and thus in the standstill of the machine.

The guide passage can converge in the conveying direction to achieve an even better shaping of the paper web before entry into the guide passage. A reshaping of the paper web into its unshaped state can hereby simultaneously be avoided after it has left the deflection device.

In accordance with a further embodiment of the present invention, the deflection passage can be curved such that the paper web undergoes a change in direction of at least 90° therein. In this manner, the paper web can be supplied to the shaping device from below as with the known apparatus, on the one hand, but a direct expulsion of the manufactured paper cushion from the guide passage can be achieved in a downwardly orientated direction, on the other hand, so that only slight modifications have to be made to the known machines with respect to the shaping device, on the one hand, but a very reliable expulsion of the paper cushions from the guide passage can be ensured, on the other hand.

Furthermore, the extent of the total machine can be kept small, observed in a defined direction, by a deflection passage curved by at least 90°. The shaping device can thus be aligned horizontally, for example, so that the shaping of the paper web takes place in a horizontal direction. If now a deflection passage is provided which is curved by at least 90°, the guide passage can be arranged with respect to the shaping device such that the paper web is transported through the guide passage either at, for instance, a right angle with respect to the conveying direction through the shaping device or even undergoes a reversal of direction, whereby the dimensions of the machine in the conveying direction through the shaping device can be kept small, on the one hand, and the total height of the machine can also be reduced, on the other hand.

A direct expulsion of the paper cushions from the guide passage can advantageously be achieved in that it is orientated with respect to the shaping device such that the input direction of the paper web into the guide passage deviates from the output direction of the paper web from the shaping device. This can be achieved particularly simply using the individual components of the machines already mentioned above in that the whole housing in which the guide passage is located is inclined with respect to the horizontal independently of the shaping device. Only a decoupling of the shaping device from the housing in which the guide passage is located is thus necessary so that the housing only has to be pivoted to achieve the desired expulsion of the paper cushions from the guide passage. The inclination of the housing with respect to the horizontal additionally proves to be advantageous in that the housing takes up less space considered in the horizontal direction.

As can be seen from the preceding statement, a supply of the paper web to the shaping device from below in a rising first direction with a first gradient can therefore be achieved, with the input of the paper web into the guide passage likewise being able to take place in a rising second direction with a second gradient which is smaller than the first gradient. Since the second gradient is smaller than the first gradient, a direct expulsion of the paper cushions out of the guide passage can be ensured even if the first gradient approaches the vertical. For reasons of completeness, it must be mentioned at this point that in this connection a slope is also to be interpreted as a (negative) gradient so that, for example, the guide passage can also be downwardly inclined considered in the conveying direction.

The present invention is particularly suitable for heavy supply rolls, high processing speeds and papers with a low tear resistance. The cushions to be manufactured with the machine in accordance with the invention can be individual cushions or also endless cushions, with a cutting member being able to be provided in the housing for the division of the endless cushions into individual cushions for the manufacture of individual cushions.

The present invention will be described in the following purely by way of example with reference to advantageous embodiments and to the enclosed drawings, wherein:

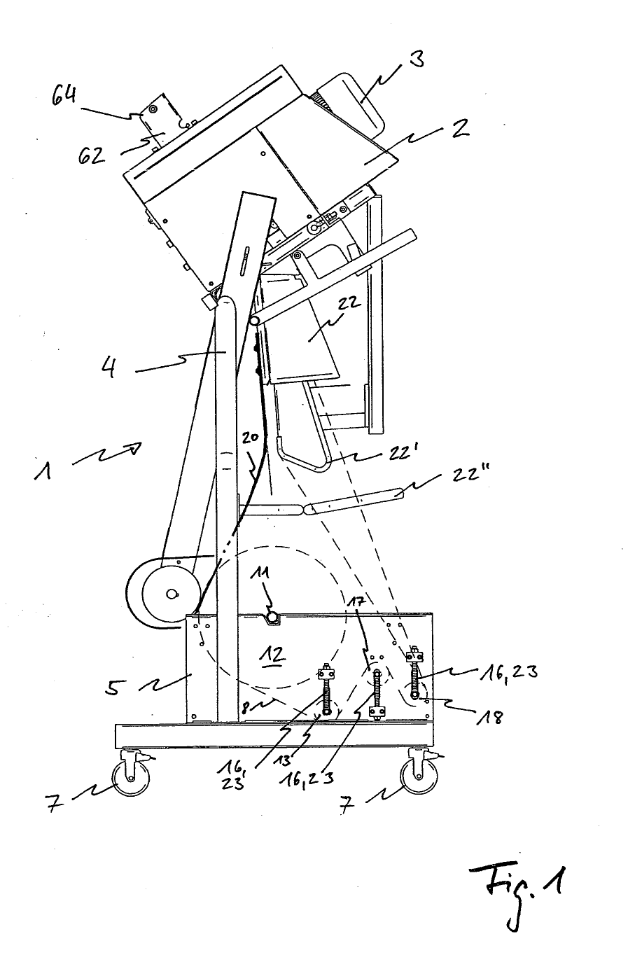

FIG. 1: shows a schematic side view of a machine for the manufacture of paper cushions;

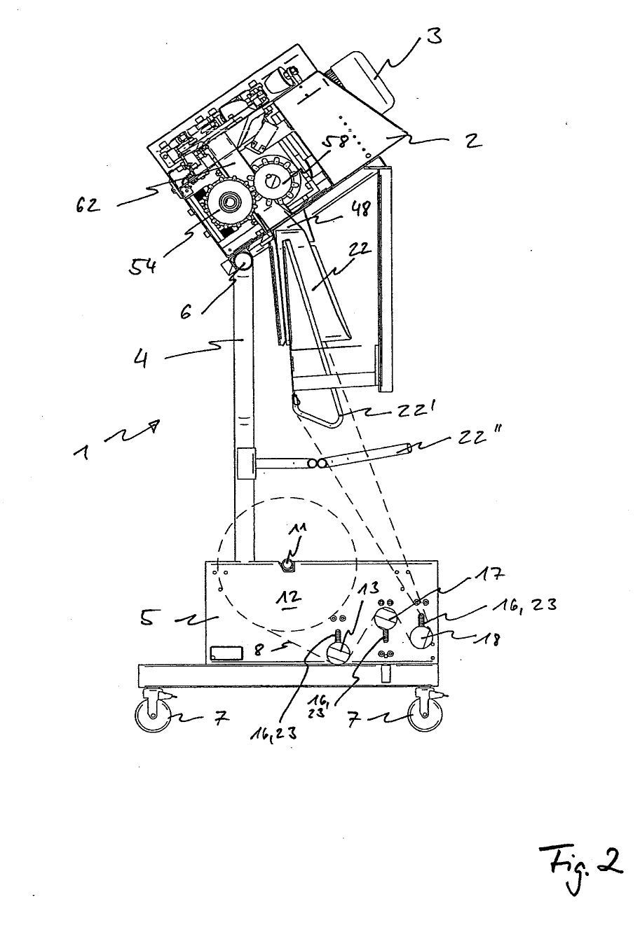

FIG. 2 shows a schematic sectional representation of the machine of FIG. 1;

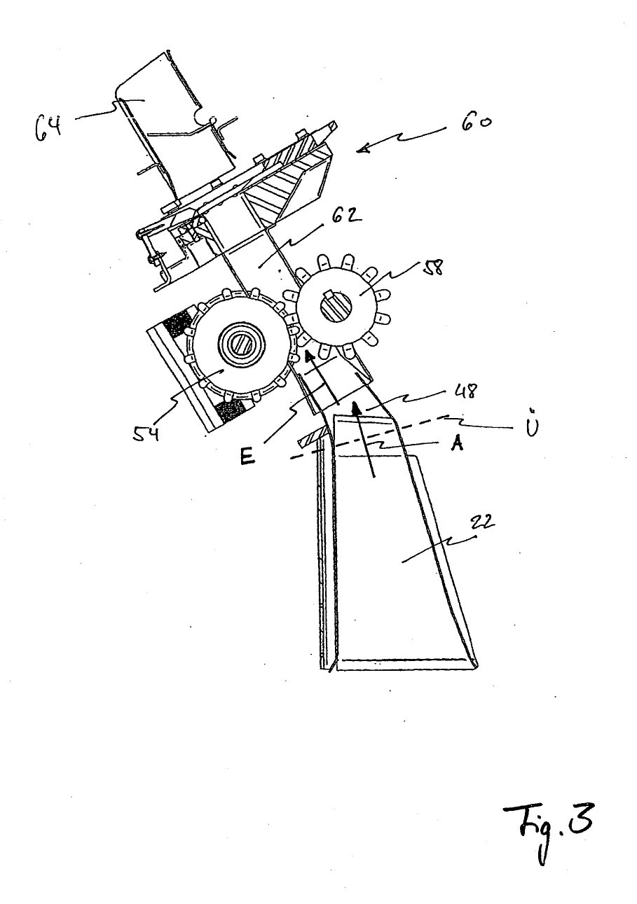

FIG. 3 shows an enlarged section from FIG. 2 in the region of the guide passage and the shaping device;

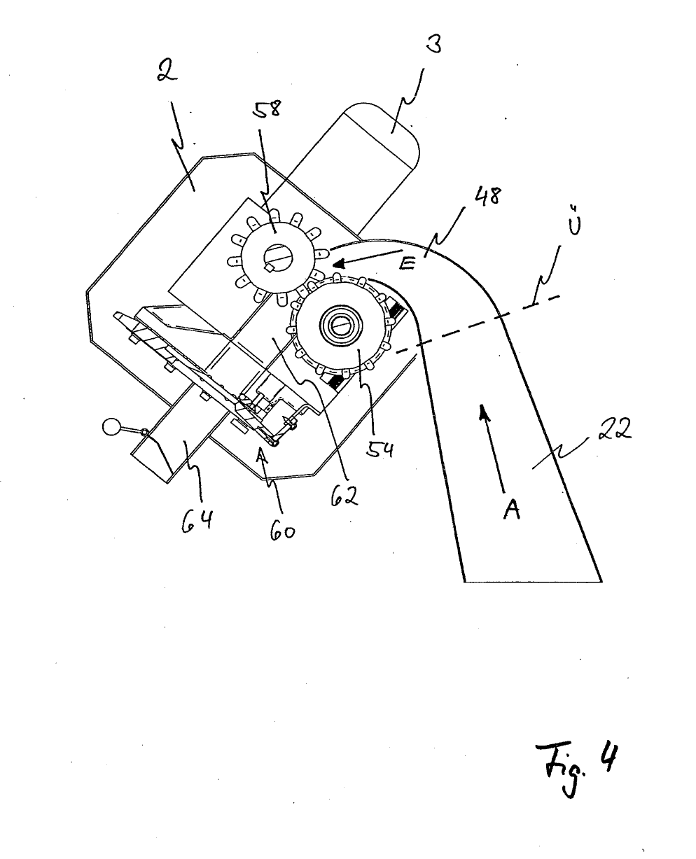

FIG. 4 shows an alternative embodiment in the region of the shaping device and of the guide passage with a pronouncedly curved deflection passage;

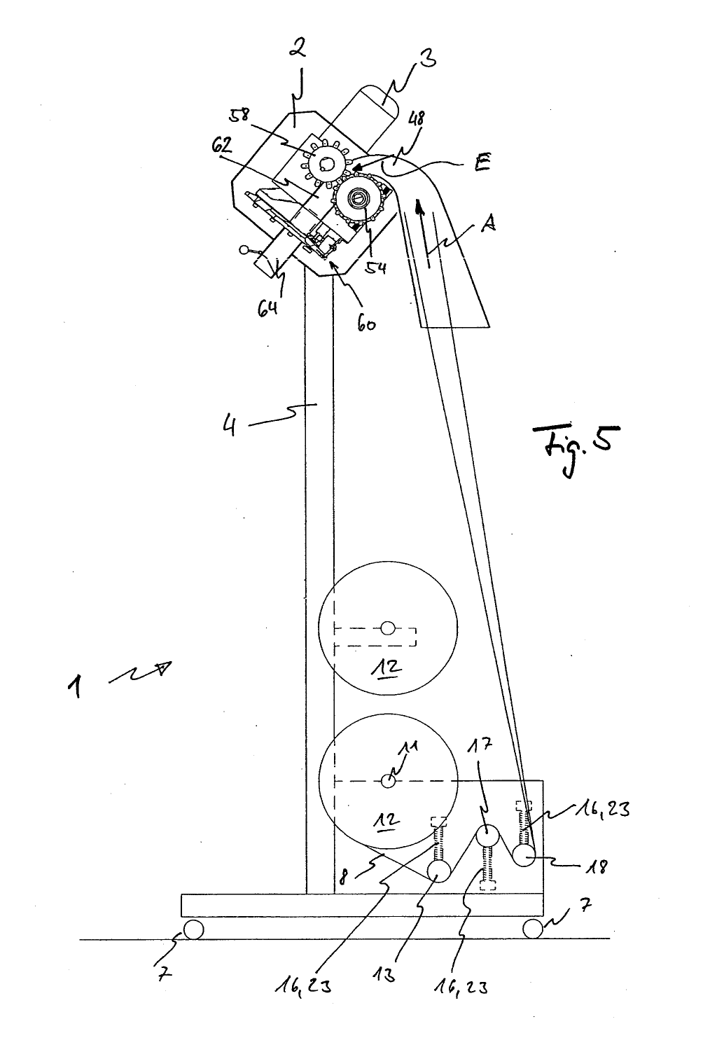

FIG. 5 shows a schematic sectional representation of another machine for the manufacture of paper cushions with a curved deflection passage in accordance with FIG. 4; and

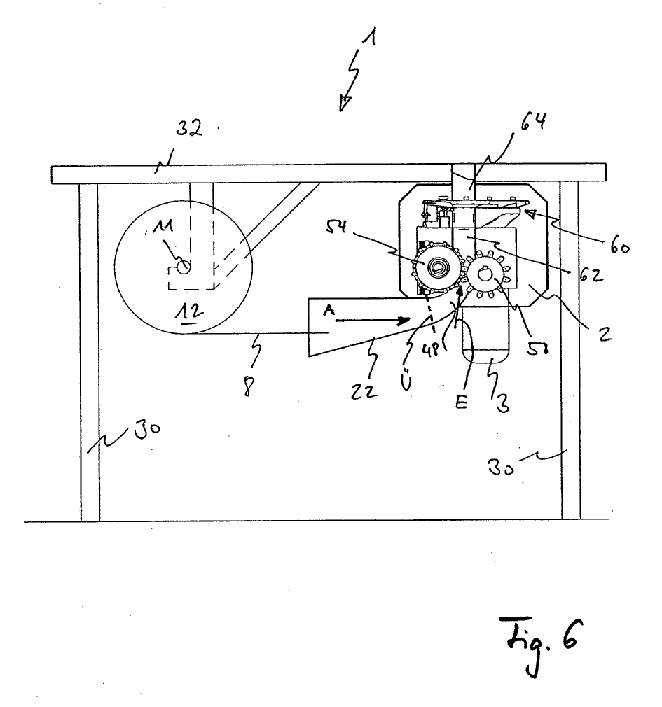

FIG. 6 shows a schematic sectional representation of yet another machine for the manufacture of paper cushions with a desk-like rack.

The general design of the machine for the manufacture of cushion-like material or of paper cushions will first be described in the following with reference to FIGS. 1 and 2, said machine being substantially divided into a rack 1 and a substantially parallelepiped housing 2. A drive provided with a motor 3 is located in the housing 2 to pull a paper web 8 through a shaping device 22, 22′, 22″ and to shape a cushion out of the paper web.

The rack 1 substantially consists of a frame 4, two side parts 5 which are formed as shield supports and are fastened standing freely to the rack 1 and a carrier 6 which can be pivotally fastened to the frame 4. A plurality of wheels 7 are provided at the rack 1 to be able to move the machine.

An arrangement to supply the paper web 8 is provided in the rack 1. The arrangement includes a shaft 11 for a supply roll 12 having a paper web 8 consisting of at least one paper ply. Furthermore, deflection rolls 13, 17 and 18 are provided parallel to one another. The shaft 11 of the supply roll 12 is supported at the side parts 5 of the rack 1. The deflection rolls 13, 17 and 18 are each supported with their shafts in elongate holes 16 which are formed substantially vertically in each side part 5. The individual deflection rolls 13, 17 and 18 are movable against the force of springs 23 within the elongate holes 16 to hold the paper web 8 under tension.

A brake band 20 which can, for example, consist of spring steel contacts the outer periphery of the supply roll 12 (FIG. 1). A funnel-shaped chute 22 which tapers in the conveying direction is provided for the introduction of the paper layers into the housing 2.

A supply roll 12 is placed into the rack 1 to prepare for the operation of the machine. As already mentioned, the shield supports 5 are fastened in a free standing manner to the rack 1 for this purpose so that the deflection rolls 13, 17 and 18 are freely accessible. The supply roll 12 provided with the shaft 11 is rolled, as shown in FIG. 1, onto a cut-out provided for the support of the shaft 11. In this position, the supply roll 12 comes into contact with the brake band 20 so that an unwanted unwinding of the paper web 8 is prevented. The paper web 8 is subsequently guided over the deflection roll 13 to the deflection rolls 17 and 18 where it is finally separated into two separate paper plies (FIG. 1). Subsequently, the ends of the paper plies are introduced into the chute 22. Not only the chute 22 serves for the shaping of the paper web in this process, but also the shaping 22′ and 22″ which effect a lateral rolling in or folding in of the paper web in joint cooperation with the chute 22.

A drive to convey the paper web 8 is provided within the housing 2 which is closed per se. As can be seen from the magnified representation of FIG. 3, the drive has at least one toothed roller pair comprising two mutually meshing toothed rollers 54, 58. The at least one toothed roller pair 54, 58 is arranged in the region of a guide passage 62 through which the paper web 8 preshaped by the shaping device 22, 22′, 22″ is conveyed. At least one of the two rollers 54, 58 is driven by the motor 3 so that the paper web 8 is pulled through the roller gap of the two rollers 54, 58 by the rotation of the two mutually meshing rollers 54, 58 and is crumpled in this process.

As can be seen from the FIGS. 1 to 3, the guide passage 62 is orientated with respect to the shaping device 22, 22′, 22″ such that the input direction E of the paper web 8 into the guide passage 62, which represents a first direction to this extent, differs from the output direction A of the paper web 8 from the shaping device 22, 22′, 22″, with the output direction A being able to be considered the second direction in the sense of the invention. In other words, the paper web 8 is deflected between the shaping device 22, 22,′ 22″ and the guide passage 62, which is due to the fact that the guide passage 62 is inclined with respect to the output direction A of the paper web 8 from the shaping device 22, 22′, 22″. It can thus be ensured by the inclined alignment of the guide passage 62 that the individual paper cushions do not fall out of the passage 62 without order at the exit opening 64 of the guide passage 62. The paper cushions rather fall out of the exit opening 64 of the guide passage 62 in a defined direction due to gravity as a consequence of the inclined alignment of the guide passage 62 so that they can be collected directly by a storage container to be arranged beneath the exit opening 64 of the guide passage 62.

As can be seen from FIGS. 1 and 2, in the embodiment shown, the total housing 2 is inclined with respect to the horizontal, whereby the extent of the machine can be kept small in the desired manner in the horizontal direction.

For reasons of completeness, it should be mentioned at this point that a cutting member 60 is shown in the region of the guide passage 62 in FIGS. 2 and 3 which serves to divide the paper product initially present as endless cushions into individual paper cushions.

As can best be seen from FIG. 3, the converging section of the funnel-shaped chute 22 merges at the line drawn with a broken line in FIG. 3 into a deflection passage 48 which tapers in the conveying direction and which serves to directly deflect the paper web 8 between the funnel-shaped chute 22 and the guide passage 62. In the embodiment shown in FIG. 3, the deflection passage 48 has only a slightly curved design so that the paper web 8 undergoes a change in direction of approximately 30°.

In accordance with an alternative embodiment, the deflection passage 48 can, however, also be curved substantially more pronouncedly as is shown, for example, in FIGS. 4 and 5. In the embodiment shown in FIG. 4, the total housing 2 is pivoted around approximately 90° with respect to the embodiment of FIGS. 1 to 3, but otherwise corresponds to the basic design of the housing of FIGS. 1 to 3. In FIG. 4, the funnel-shaped chute 22 merges continuously in the region of the line drawn in broken form into the tapering deflection passage 48 which is curved so far here that the paper web 8 undergoes a change in direction therein of approximately 100 to 120°. It is possible due to the high curvature of the deflection passage 48 to incline the guide passage 62 downwardly considered in the conveying direction so that the exit opening 64 of the guide passage 62 faces downwardly. A particularly direct supply of the manufactured paper cushions from the guide passage 62 is thereby made possible, on the one hand. On the other hand, the dimensions of the functional unit of shaping device 22, 22′, 22″ and housing 2 can be kept small in the output direction A, as can be seen from the comparison of FIG. 5 and FIG. 2.

To add a further paper web, for example a coated or impregnated paper web, to the packing material, a further supply roll 12′ having such a paper web can be stored at the rack 1, as is shown, for example, in FIG. 5. The paper web of this supply roll 12′ can be pulled through the shaping device 22, 22′, 22″ in addition to the paper web 8 and can be guided through the guide passage 62 with the help of the roller pair 54, 58 to connect the additional paper ply to the other paper plies.

Although no shaping device is shown in FIG. 5 for reasons of clarity, the embodiment of the machine shown in FIG. 5 naturally also has a shaping device 22, 22′, 22′ in accordance with the embodiment shown in FIGS. 1 to 3 so that reference can be made thereto to this extent.

The function of the machine described above will be explained with reference to FIGS. 1 to 3 in the following.

During operation, the deflection roll 13 lies on the paper web 8 with its own weight to hold the paper web 8 under tension. The deflection rolls 17 and 18 likewise lie on the paper web 8 with their own weight to tension the individual paper plies, on the one hand, and to ensure a uniform supply of the paper plies, on the other hand. When the apparatus is started, the guide rolls 13, 17 and 18 can be raised in the elongate holes against the force of the springs 23 so that a problem-free start-up is possible even with a heavy supply roll 12.

After the machine or its motor 3 has been started, the paper 8 is coiled off the supply roll 12 in that the paper web 8 is transported through the two mutually meshing rollers 54, 58, whereby the paper web 8 preshaped by the shaping device 22, 22′, 22″ is additionally crumpled in on itself in order to shape a cushion material out of it which is as soft and as voluminous as possible. The cushion material initially present as an endless web is subsequently divided by the cutting member 60 in the guide passage 62 into individual cushions which are finally conveyed out of the passage 62 by the respectively following paper cushions.

Since the guide passage 62 is orientated—at least in the region of its exit opening 64 from the housing—such that the paper cushions manufactured from the paper web 8 fall out of the guide passage 62 in the direction of the orientation of the exit opening 64 due to gravity, the individual paper cushions do not congest randomly subsequent to the guide passage 62. This brings along the desired effect that no additional conveying devices have to be provided to convey the individual paper cushions from the machine into a storage container since the individual paper cushions always automatically only leave the guide passage 62 directly in one direction as a result of the inclination of the guide passage 62.

Finally, an alternative embodiment of a machine in accordance with the invention for the manufacture of paper cushions will be described with reference to FIG. 6. In the embodiment shown in FIG. 6, the rack 1 is made as a frame-like support table which stands firmly on the floor with four legs 30. The legs 30 are connected to one another pairwise in each case by a transverse bolt 32 at which a supply roll 12 as well as a housing 2 with a guide passage 62 located therein and with a shaping chute 22 is arranged in suspended manner. A paper web 8 is supplied from the supply roll 12 via a tensioning device not shown here in accordance with the deflection rolls 13, 17, 18 from FIGS. 1 and 2 to the shaping chute 22 which here merges continuously into a deflection passage 48 which is curved so far here that the paper web 8 undergoes a change in direction of approximately 90° therein. The paper web 8 is subsequently stamped in the manner already described by the mutually meshing toothed rollers 54, 58 to form a cushion which is conveyed out of the exit opening 64 through the guide chute 62.

In the embodiment shown in FIG. 6, the paper web 8 is thus first supplied to the shaping device 22 in a horizontal direction in order subsequently to be deflected into the guide passage 62 by 90° in the deflection passage 48 so that the extent of the production line of the machine can be kept small in this manner both in the horizontal direction and in the vertical direction.

It must finally be mentioned that also no shaping device is shown in the embodiment shown in FIG. 6 for reasons of clarity. However, the machine shown in FIG. 6 naturally also has a shaping device 22, 22′, 22″ in accordance with the embodiment shown in FIGS. 1 to 3 so that reference can be made thereto in this respect.

### REFERENCE NUMERAL LIST

1 rack
2 housing
3 motor
5 side part
6 carrier
7 wheels
8 paper web
11 shaft
12, 12′ supply roll
13 deflection roll
16 elongate hole
17 deflection roll
18 deflection roll
20 brake band
22, 22′, 22″ chute, shaping device
30 leg
32 transverse bolt
23 spring
48 deflection passage
54 toothed roller
58 toothed roller
60 cutting member
62 guide passage
64 exit opening
A outlet direction from 22
E inlet direction into 62
U transition between 22 and 48

1-9. (canceled)

10. A machine for the manufacture of paper cushions comprising:
a shaping device (22, 22′, 22″); and
a housing (2) through which a guide passage (62) passes and in which a drive (3, 54, 58) is provided to convey a paper web (8) along a main transport direction through the shaping device and the guide passage (62),
wherein
a deflection takes place in the main transport direction from a first direction (A) into a second direction (E) due to at least one of an arrangement of the guide passage (62) and a design of the guide passage (62) after the paper web (8) exits the shaping device (22, 22′, 22″).

11. A machine in accordance with claim 10, wherein the guide passage (62) is inclined at an oblique angle with respect to the first direction (A).

12. A machine in accordance with claim 10, wherein the shaping device (22, 22′, 22″) has a deflection region in which the paper web (8) undergoes the change in direction.

13. A machine in accordance with claim 12, wherein the deflection region has an at least partly curved deflection passage (48).

14. A machine in accordance with claim 13, wherein the deflection passage (48) tapers in the conveying direction.

15. A machine in accordance with claim 13, wherein the deflection passage (48) is curved such that the paper web (8) undergoes a change in direction of at least 90° therein.

16. A machine in accordance with claim 10, wherein the second direction (E) is orientated such that paper cushions manufactured from the paper web (8) fall out of the guide passage (62) in the direction of the orientation of the second direction (E) due to gravity.

17. A machine in accordance with claim 10, wherein the housing has a substantially parallelepiped design and is inclined with respect to the horizontal.

18. A machine in accordance with claim 10, wherein the supply of the paper web (8) to the shaping device (22, 22′, 22″) takes place in a horizontal direction and the output of the paper web out of the guide passage (62) takes place in a vertical direction.
